(19) United States
(12) Patent Application Publication
(10) Pub. No.: US 2010/0011054 A1
(43) Pub. Date: Jan. 14, 2010

(54) Portable Media Delivery System with a Media Server and Highly Portable Media Client Devices

(76) Inventor: Yang Pan, (US)

Correspondence Address: Yang Pan, Shimao Riviera Garden, Wei Fang Rd. (W), Lane 1, Block 9, Unit 8A, Shanghai, 200122, CN

(21) Appl. No.: 12/172,270

(22) Filed: Jul. 14, 2008

(51) Int. Cl. G06F 15/16

(52) U.S. Cl. 709/203; 709/206

(57) ABSTRACT

A portable media delivery system is disclosed. According to one aspect, the media delivery system comprises a portable media server and at least one client device. The client device is a plug and play apparatus for the server. A processor in the media server controls the operations of the client devices directly or through a processor in the client device when connected. In one of the implementation, the client device is an audio player that lacks of a user interface display and of any visible user input device. Motion sensors that are accelerometers in our preferred embodiment are integrated with earphones. The sensors are used to input user's instructions. An example is for the sound volume adjustment by a user weaving an earphone with an integrated motion sensor. The portability of an audio player is greatly improved. The media assets associated with a playlist selected by a user in the media server is transferred, by a wired or wireless connection, to the audio player along with a selected playing mode from the options of ‘continuous’ and ‘shuffled’. According to another aspect, a detachable client device is an integrated enabling part of a media device. The media assets selected by a user are stored in the cache of the device. The cache containing the selected media assets as a part of the detachable device is separated from the host when a user detaches the client device. The client device can be used independently while the media device ceases to be functional after the client device is removed in such an implementation.

### CROSS-REFERENCE TO RELATED APPLICATIONS

Not applicable.

### BACKGROUND

1. Field of Invention

This invention relates to a media delivery system, specifically to a portable media delivery system with a media server and highly portable media client devices.

2. Description of Prior Art

A portable media player stores media assets such as songs and video clips, which can be played on the device. Examples of media players are the iPod from Apple Inc. of Cupertino, Calif., the Zen from Creative Technology Ltd, Singapore and the Zune from Microsoft Inc of Redmond, Wash. A media player acquires typically its media assets from a computer with media management applications, such as the iTunes software, which is a product from Apple. The portable media players have gained popularity because of its capability to store large number of media assets in a device, which can be put into a user's pocket when he or she is moving around. The large number of media assets are organized in a way of automatic hierarchical categorization by metadata as disclosed in a U.S. Pat. No. 6,928,433 to Goodman and Egan (2005). Portable media players with wireless communication capabilities have been disclosed by Fadell, et al in a US patent application 2008/0125031. The use of the wirelessly connected portable media players to form a local network for the peer-to-peer information sharing has also been disclosed by Panabaker et al in a US patent application 2008/0005353, by Haveson et al in 2007/0297426 and by Kirovski and Jain in 2007/0136608.

Despite of the gained popularity of the portable media players, there are two conflicting requirements for the device. On one hand, it is becoming popular to integrate multiple functions into a single handheld device. For example, an iPhone from Apple can be used as a mobile phone, an internet connection device and a media player. A relatively large display screen is required for viewing video assets and for a reasonable internet experience. Furthermore, more functionality requires more powerful and bulky batteries to provide a reasonably long battery lifetime before having to recharge the player or replace the player's battery. On the other hand, for some users, the compactness of the player is a critical requirement, in particular when it is used for wearing to have a physical exercise. These conflicting requirements result in different types of portable media players in the market for different applications. It is, however, not always convenient for a user to maintain multiple portable media players for different occasions while using the same media database in a personal computer.

In US patent application 2008/0013274, Jobs et al disclosed an art to have an improved portable media device. The form factor of the device is handheld or smaller by eliminating the display screen that is typically integrated with a portable media player. It was recognized by Jobs et al that a user would encounter difficulties to use a display screen integrated with a reduced size device. The improved device, however, is still rather bulky with regards to wearing it for a physical exercise because of the presence of the user interface devices as described in the disclosure. Furthermore, a host computer with additional management and communication modules (software) is used to manage the media assets transfer to the portable device.

Therefore, what is desired is a portable media device with even smaller size that is suitable for a user to carry to have a physical exercise. What is further desired is a portable media delivery system including a portable media server and highly portable client devices. The server is a portable device that can be used as an audio and video player, a mobile communication and an internet connection device. The highly portable media client devices could be a stripped-down version of media devices that comprises much reduced number of components. The media client device is ideally a plug and play apparatus for the server, from which it receives selected media assets by a user. The media client device is in particularly compact in size and consumes very little power and may ideally be worn by a user to carry out a physical exercise.

It should, in particularly, be noted that using a portable media server is very much desirable. With the increased functionality and the internet connection capabilities associated with the broadband wireless network, a portable media and communication device may become the mainstream media server to replace a general purpose computing apparatus in a visible future. By owning a portable media server and a highly portable media client device, a user can use the media server for a more extensive media and internet experience while using the highly portable client device for enjoying a few favorite songs when one is having a physical exercise. Furthermore, multiple users with a different client device may share a media server with the great ease of use.

Accordingly, it is a purpose of the present invention to provide a portable media delivery system including a portable media server and at least one highly portable media client device, wherein a processor from the server controls operations of client devices when connected.

It is a further purpose of the present invention to provide a highly portable media client device with much reduced number of components, which does not require a display screen and any visible user input device.

It is yet a further purpose of the present invention to provide methods to utilize embedded motion sensors to control the operations of a portable media device.

It is still a further purpose of the present invention to provide a method to synchronize, on a real time base, a list of user selected media assets in a folder in the media server with assets in the media client devices.

### SUMMARY OF THE INVENTION

A portable media delivery system comprises a portable media server and at least one highly portable media client device. In one embodiment, the server and the client device are two independent devices. In one aspect of the invention, the server and the client device are connectable through a convention wired connection by use of a Universal Serial Bus (USB) type of connection. The client device can include a peripheral bus connector that enables the device to removably and easily connect to a peripheral bus port operatively coupled to the portable media server. The client device can, therefore, communicate with the host device without using cables or other support devices. The client device is a plug and play apparatus for the server in such an implementation. The USB type of connector as known in the art includes both power and data functionality, thereby allowing both power delivery and data communication to occur between the client device and the portable media server. In some cases, the portable media server powers or charges the client device when connected.

In another aspect of the present invention, the portable media server and the client devices are connected through a wireless communication means that conforms to one of the various IEEE wireless communication standards, such as the IEEE 802.15.1 (Bluetooth standard). In such an implementation, multiple client devices may be connected to the server concurrently.

The portable media server is a media player in our preferred embodiment. The portable media server comprises a processor and a file system that is typically a flash memory or a plurality of flash memory. It further comprises user interface unit such as a Liquid Crystal Display (LCD) screen and a user input device such as a rotational interface used in an iPod from Apple. The file systems stores media assets. A user selects a media asset from the user interface. The processor receives the selection and controls the operation of sending the selected media asset to coder/decoder (CODEC) for the signal processing to generate analog signal for further delivering to earphones for an audio experience in case of an audio player. A battery, more particularly, a rechargeable battery is used to provide power for the server.

The media client device is a stripped-down version of a media player and in particularly is an audio player in our preferred embodiment. The display screen and the user input devices are eliminated to further reduce the size of the device. The media client device comprises a processor, a cache and a CODEC. The media assets transferred through the wired or wireless connection from the media server are stored in the cache of the client device. A battery is required to operate the device. The battery may be a rechargeable battery. In some cases, the battery can be recharged via a peripheral bus.

A folder containing a playlist of media assets for a specific user is maintained. The playlist may be selected by the user in a way similar to the playlist selected in the folder ‘On-The-Go’ from some types of the iPod devices from Apple. When a user intends to use the client device independently, he or she connects the device with the portable media server via an USB connection. When connected, existing media assets stored previously in the cache of the client device are removed. The selected media assets associated with the playlist in the folders are then sent to the cache of the client device via the USB connection in a sequential way according to the playlist. The other media information including the mode of the playlist as ‘continuous’ or ‘shuffled’ can also be sent to the cache and be received by a processor in the device. The user may further modify the playlist during the media asset transfer. In such a circumstance, the newly added media assets are listed one after another from the bottom of the existing playlist. Since the transfer of the associated media files to the cache of the client device is sequential, adding new items to the playlist does not affect the transferring of the existing playlist to the cache. Moreover, as long as the new items are added and the transferring of the existing media files is completed, the processor controls the transfer of the newly added items immediately. On the other hand, if the user deletes existing items in the playlist in the media server, the associated media assets will be removed from the cache of the client device if they have already been received. The operation can be controlled by the processor in the media server, which controls the operation of the client device via the data bus when connected.

In another embodiment, the media client device is a subsystem of the portable server, which is detachable from the portable media server. In such an implementation, the client device as a part of the media server is connected to the host through a convention connector such as an USB type of connector. The client device as an audio player, comprising a processor, a cache, a CODEC and a battery, is an integrated part of the portable media server. The cache stores media files from a selected folder of the media file system of the server. When detached, the client device operates independently with the selected media assets in the cache while the media server ceases to be functional.

The present invention further discloses methods for adjusting sound volume by utilizing of motion sensors. Because of this innovative feature, a media player as an audio player can be constructed without a display screen and without any visible user input device. The motion sensors, which are silicon accelerometers in our preferred implementation, are embedded in earphones. The silicon accelerometer manufactured by a process based on the integrated circuit is tiny and can be embedded into an earphone without increasing its size in a visible way. Two accelerometers are used to adjust the sound volume. Each earphone contains one of them. One is named as the ‘up-sensor’ to increase the volume and another as the ‘down-sensor’ to reduce the volume. The sound volume adjusting operation can be carried out by a user selecting one of the earphones and holding the device at a hand and weaving the device. The processor identifies if the signal comes from the up-sensor or from the down-sensor and controls an operation to adjust the volume accordingly. The two earphones with the opposite volume adjusting functions can be identified by the user with a different visual symbol on the surfaces of the earphones. For example, a red dot on an earphone identifies it for the adjusting up the volume and a green dot for the adjusting down the volume. The sensors are powered by the same battery that providing power for the player.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a diagram of portable media delivery system illustrating a wired and a wireless connection between a media server and media client devices.

FIG. 2 is a schematic functional block of a portable media delivery system with a portable media server and a highly portable media client device.

FIG. 3A is a simplified diagram of the synchronization of media files between different levels of media devices.

FIG. 3B is a simplified diagram of synchronization of media files between the portable media server and the highly portable media client device.

FIG. 4 is a diagram of a portable media device with a detachable client device.

FIG. 5 is a schematic functional block of a portable media device with a detachable sub-system as an audio player.

FIG. 6 is a flow diagram of the method to use a pair of motion sensors embedded in earphones to control the sound volume of a media client device.

FIG. 7 is a flow diagram of the method to use a motion sensor embedded in the media client device to control the ‘pause’ and ‘restore’ operations.

### DETAILED DESCRIPTION

References will now be made in detail to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims.

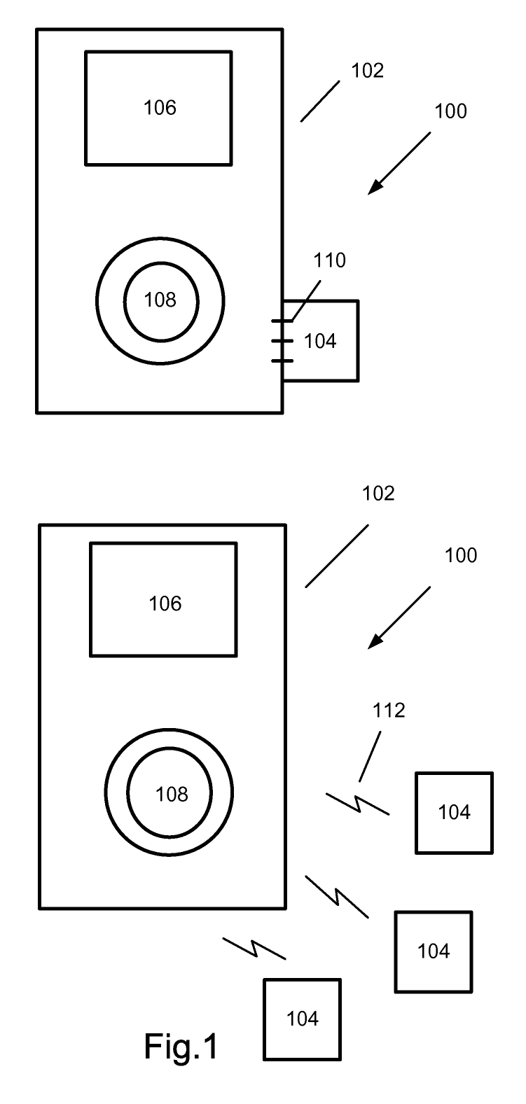

FIG. 1 shows a diagram of a portable media delivery system 100. According to one implementation, the portable media delivery system 100 includes a server 102 and a media client device 104 connected to the server. The portable media server further comprises a user interface unit 106 such as a LCD screen and a user input device 108 such as a rotational user interface used in an iPod from Apple. The connection 110 between the two devices includes an USB type of connection. The client device 104 can include a peripheral bus connector that enables the portable media device to removably and easily connect to a peripheral bus port operatively coupled to the portable media server 102. The client device 104 can, therefore, communicate with the media server 102 without using cables or other support devices. The client device 104 is a plug and play device in such an implementation. The USB type of connector 110 as known in the art includes both power and data functionality, thereby allowing both power delivery and data communication to occur between the audio player and the portable media server. In some cases, the portable media server powers or charges the audio player when connected.

In another implementation, the portable media server 102 and the client devices 104 are connected through a wireless means 112 by using the wireless network interfaces. The data can be transmitted between the media server and the client devices via a wireless link that conforms to various IEEE standards such as IEEE 802.11 (Wi-Fi), IEEE 802.15.1 (Bluetooth) and IEEE 802.15.4 (Zigbee) and their extensions. It should be noted that a plurality of client devices 104 can be connected to the portable server 102 concurrently when connected wirelessly.

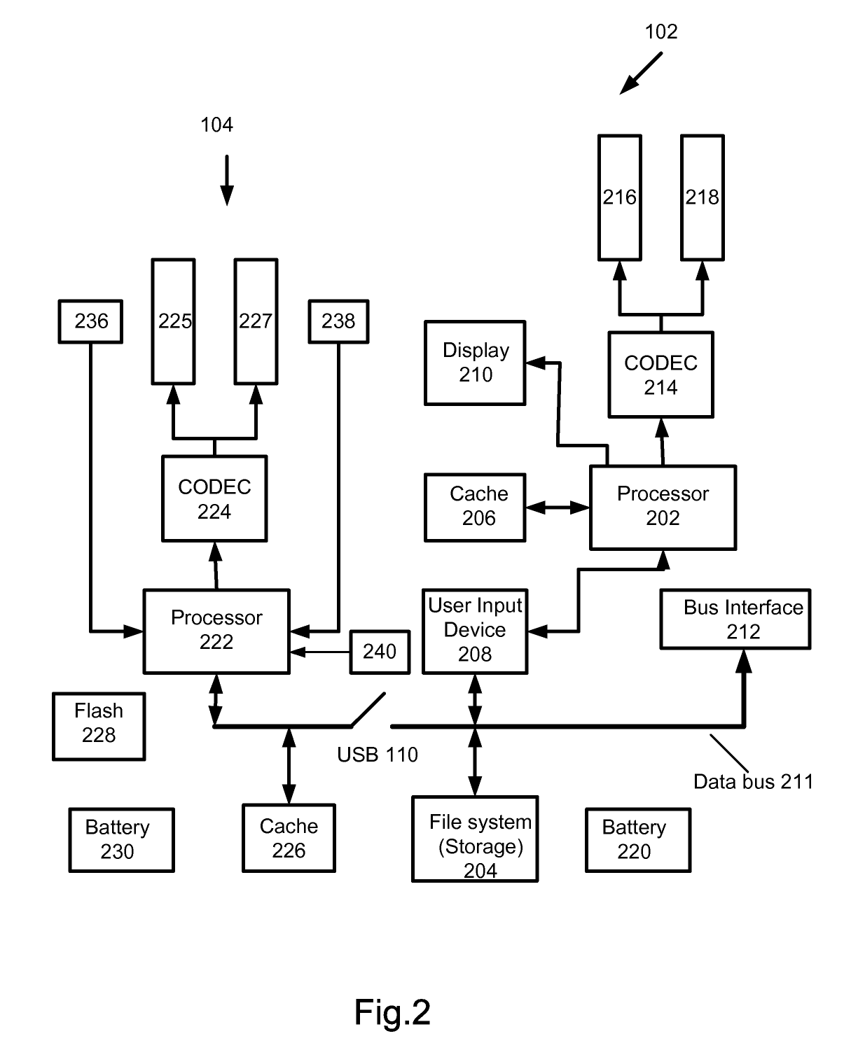

FIG. 2 is a schematic functional block of a portable media delivery system 100 with a portable media server 102 and a highly portable media client device 104. The portable media sever 102 is a media player in an exemplary case, including a processor 202 that pertains to a microprocessor or a controller for controlling the overall operation of the media player 102. The media player 102 stores media data pertaining to media assets in a file system 204 and a cache 206. The file system 204 is, typically, a flash memory or a plurality of flash memories or a storage disk or a plurality of disks. The file system 204 typically provides high capacity storage capability for the media player 102. However, since the access time to the file system 204 is relatively slow, the media player 102 can also include a cache 206. The cache 206 is, for example, Random-Access Memory (RAM) provided by semiconductor memory. The relative access time to the cache 206 is substantially shorter than for the file system 204. However, the cache 206 does not have the large storage capacity of the file system 204. Further, the file system 204, when active, consumes more power than does the cache 206. The power consumption is particularly important when the media player 102 is a portable media player that is powered by a battery 220.

The media server 102 further includes a user input device 208 that allows a user of the media server 102 to interact with the device. For example, the user input device 208 can take a variety of forms, such as a button, keypad, dial, etc. Still further, the media server 102 includes a display 210 (screen display) that can be controlled by the processor 202 to display information to the user. A data bus 211 can facilitate data transfer between at least the file system 204, the cache 206, the processor 202, and the CODEC 214. The media server 102 also includes a bus interface 212 that couples to a data link (not shown). The data link allows the media server 102 to couple to a host computer.

The media server 102 serves to store a plurality of media assets (e.g., songs) in the file system 204. When a user desires to have the media server play a particular media item, a list of available media assets is displayed on the display 210. Then, using the user input device 208, a user can select one of the available media assets. The processor 202, upon receiving a selection of a particular media item, supplies the media data (e.g., audio file) for the particular media item to a CODEC 214. The CODEC 214 then produces analog output signals for a pair of earphones 216 and 218.

The media client device is a stripped-down version of an audio player in an exemplary case, including a processor 222, a CODEC 224, a cache 226 and a pair of earphones 225 and 227. A motion sensor, which is preferred as a silicon accelerometer, is packaged with each of the earphones. The silicon accelerometers manufactured by an integrated circuit based process is tiny and can be embedded into an earphone without increasing its size in a visible way. The sensor 236 is used to increase the sound volume and is named as ‘up-sensor’. The sensor 238 is used to reduce the volume and is named as ‘down-sensor’. It should be noted that the stripped-down version audio player 104 lacks of a display screen and a user interface device as used in the prior art. The sensors 236 and 238 with the opposite volume adjusting functions can be identified by the user with a different visual symbol on the surfaces of the earphones. For example, a red dot on an earphone 225 identifies itself for the adjusting up the volume and a green dot on the earphone 227 for the adjusting down the volume. Signals generated by the sensors and received by the processor 222 are used to control the sound volume of the earphones 225 and 227.

Yet another motion sensor 240 that is a silicon accelerometer in our preferred embodiment can be integrated into the audio player 104 to provide means to ‘pause’ or ‘restore’ the playing operation of the device. When a user decides to ‘pause’ the playing of a song by the audio player 104, one weaves the player beyond a normal way what a player could be moved during a physical exercise, i.e. the user weaves the device with a sufficient number of times beyond the normal vibration resulting from a typical physical exercise. Similarly, the user can ‘restore’ the playing operation if one weaves the player while the player is in the sleep mode.

A power supply 230, which is typically a rechargeable battery, is used to provide power for the audio player 104 including the mentioned motion sensors 236, 238 and 240. A flash memory 228 is optional for the device 104. The media files transferred from the portable server 102 are stored in the cache 226. If a flash memory 228 is added to the system, the media files may be stored in the non-volatile memory to prevent the loss of data if power supply is switched off.

A user selects a number of predetermined media assets (songs) and locates the selected playlist into a specific output folder. The number of media assets associated with the playlist located in the output folder is typically much smaller than that of the media assets stored in the file system 204 of the portable media server 102. When the audio player 104 is plugged into an open USB slot of the server 102, the processor 202 detects such an external device and sends a control signal to the cache 226 to clear up the stored media assets if any. The processor 202 then sends another control signal to the file system 204. The processor 202 selects the first media asset according to the playlist in the output folder from the file system 204 and sends the file to the cache 226 directly via data bus 211. The media assets associated with the playlist are selected sequentially and are sent to the cache 226 one after another. The received media assets in the cache 226 are stored following the same playlist in the server 102. The transferring of a selected media asset from the media server 102 to the multiple client devices may also be carried out via wireless connections in a similar manner, wherein the media assets are transmitted from a transceiver in the server and received by transceivers associated with multiple client devices. The received data will be decoded and be stored in the cache of the client devices.

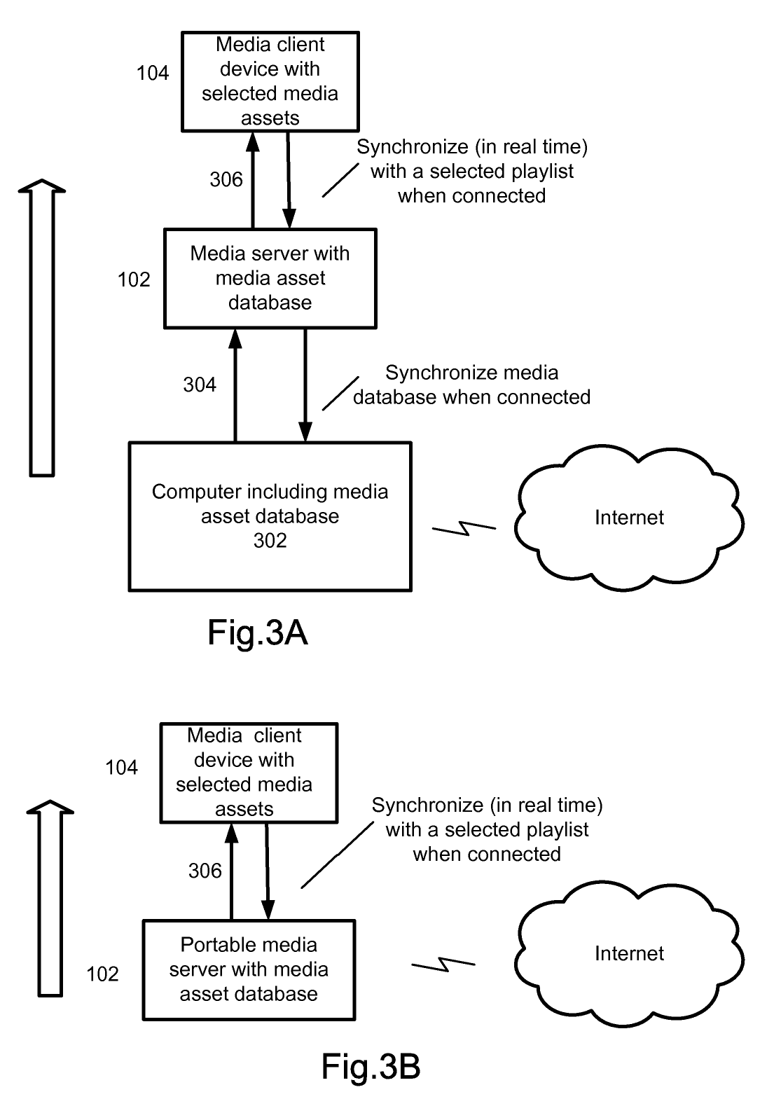

FIG. 3A is a simplified diagram of the synchronization of media files between different levels of media devices. The portable media server 102 receives, typically, media assets from a database located in a computer 302 that usually connects to the internet For example, an iPod or an iPhone receives its media assets from a database managed by the software product iTunes from Apple. The synchronization 304 is carried out by connecting the portable media server 102, which is a portable media player in our exemplary case, with the computer via a FIREWIRE (IEEE 1394 type of connection). The portable media server 102 receives a media asset database from the computer 302 and stores the assets in the file system. The media assets in the portable media client device can be synchronized with the assets in a selected folder of the media server in a real time base (306). The client device 104 receives a small number of selected media assets from the media server 102 and stores the data in its cache. The other media information such as the mode of the playlist can also be sent to the media client device 104 and be received by a processor in the device.

The user may further modify the playlist while the media server and the media client device are connected and the selected media assets are being transferred. In such a circumstance, the newly added media assets are listed one after another from the bottom of the existing playlist. Since the transferring of the associated media assets to the cache of the audio player is sequential, the operation of adding new items to the playlist does not affect the transferring the existing playlist to the cache. Moreover, as long as the new items are added and as the transferring of the existing media assets is completed, the newly added media assets are transferred immediately to the client device. On the other hand, if the user deletes existing items in the playlist from the media server 102, the associated media assets are then removed from the cache 226 of the client device 104 if they have already been received. The operation can be controlled by the processor 202 in the media server 102, which controls the operation of the client 104 via the connected data bus. The synchronization, therefore, is on real time base. The client device 104 may be detached immediately after the user completes selection of the playlist and the processor 202 confirms that the received media assets in the client device 104 matches the latest playlist in the server 102.

When the client devices 104 are connected to the media server 102 wirelessly, the method of the real time synchronization remains the same except that the data is transferred via the wireless link rather than via the connected data bus. In such an implementation, a plurality of client devices indeed can be connected to the server and receive the transferred media assets concurrently.

FIG. 3B is a simplified diagram the synchronization between the portable media server 102 and the portable media client device 104, wherein the portable media server is connected to internet directly. The computer is not required in such an implementation as a media server storing the media asset database. With the increased functionality of portable media devices, it is a matter of time before a portable device replaces a general purpose computing device (computer) as a media server for a user to manage one's media assets.

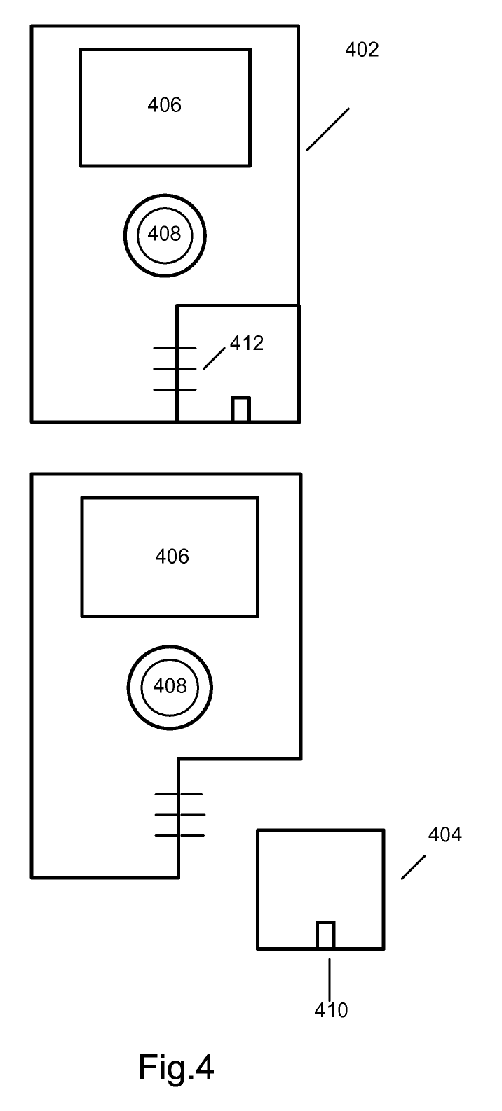

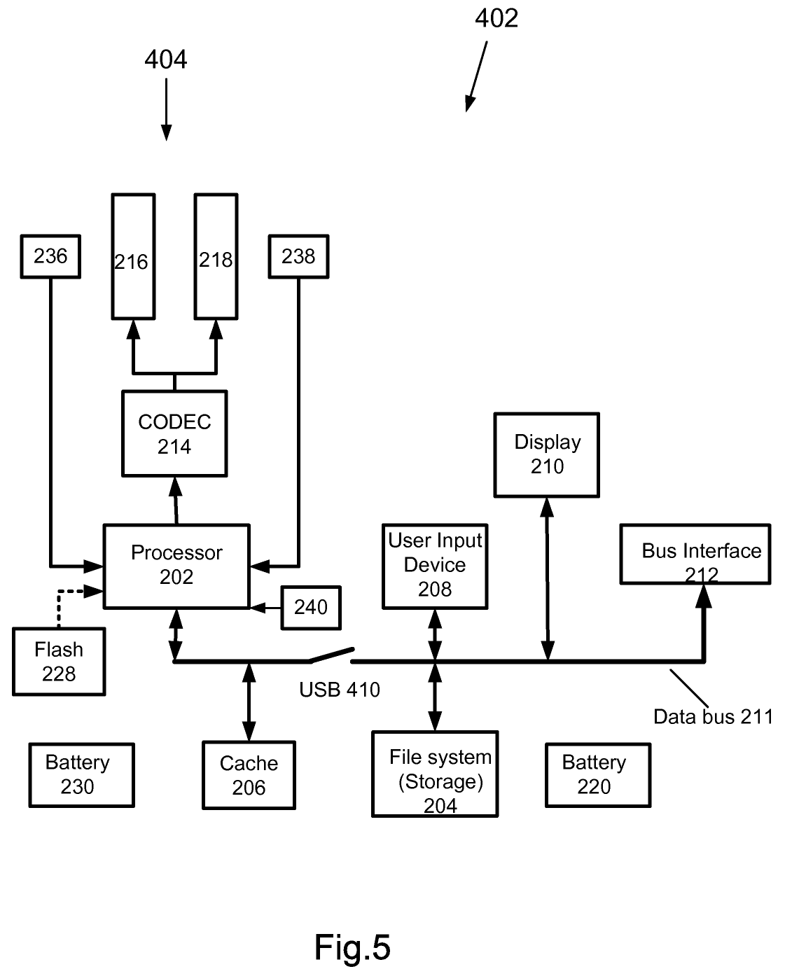

FIG. 4 shows a diagram of another embodiment of a portable media server 402, wherein the client device 404 is an integrated part of the media server 402. The media server includes a display screen 406 and a user input device 408. An earphone jack 410 is located at an edge portion of a house for the client device 404. The connector 412 connects the two units together in a conventional way including a means of USB connection. FIG. 5 shows a schematic functional block of a portable media server 402 with a detachable client device 404. When the two units are connected through the USB type of connector 412, the media server 402 is functioning as a conventional media player including all required functional blocks such as the processor 202, the file system 204, the cache 206, the user input device 208 and a display 210. The detachable client device 404 comprises part of the functional blocks of the media server with a processor 202, a cache 206, a CODEC 214, a pair of earphones 216 and 218. In addition, two motion sensors 236 and 238 that are silicon accelerometers in our preferred embodiment are added into earphones 216 and 218, respectively. Another motion sensor 240 that is also an accelerometer in our preferred embodiment is also added to the client device 404. An additional rechargeable battery 230, typically, much smaller than the battery 220 is included in the client device 404 to provide power supply. When two units are connected, the battery 220 may provide power to charge up the battery 230 through the USB type of connection. In yet another aspect of the invention, the battery 220 is located with the detachable audio player 404. The battery 230 is not required in such an implementation.

A user selects a number of predetermined media files (songs) and locates the selected playlist into a specific output folder. The number of media assets associated with the playlist located in the output folder is typically much smaller than that of the media files stored in the file system of the portable media sever 402. In the current embodiment, the media assets associated with the playlist are located in the cache 206. When a user detaches the client device 404 from the media server 402, the media assets stored in the cache 206 are detached and moved with the client device 404 at the same time. A user can then operate the client device 404 as an independent media player after the separation while the remaining portion of the media server 402 ceases to be functional.

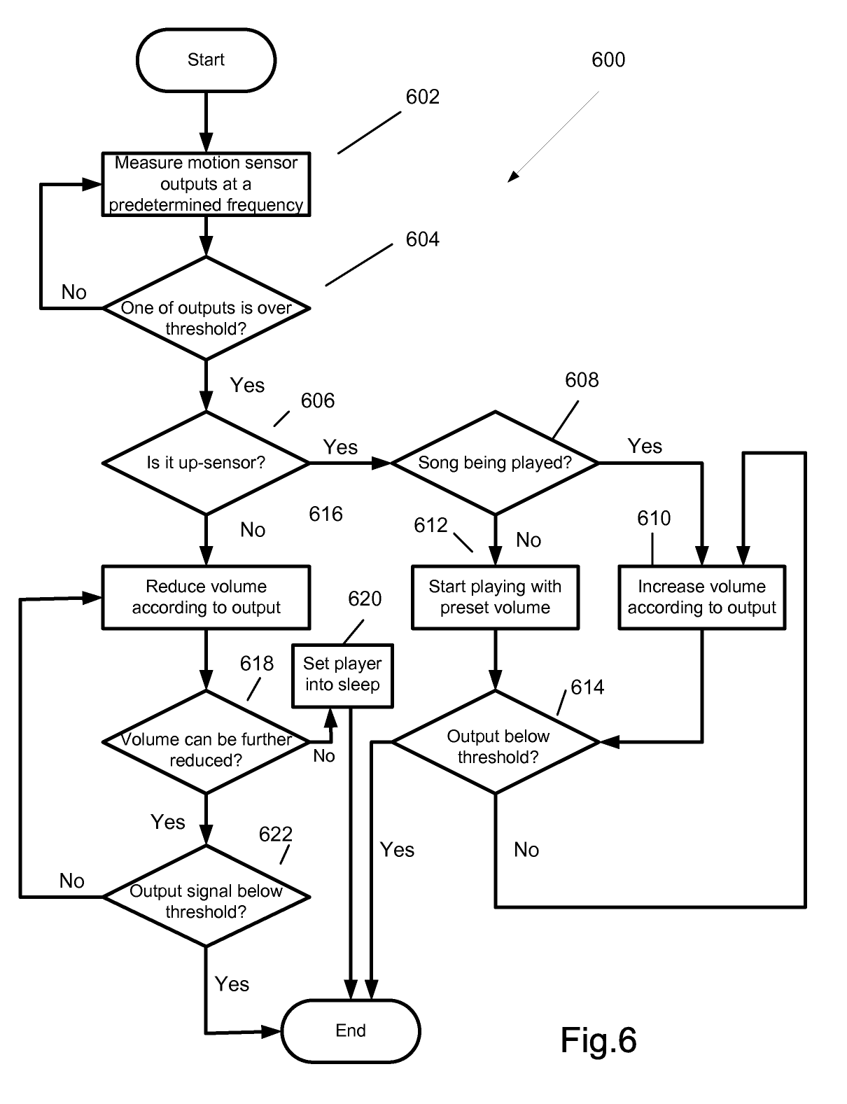

FIG. 6 is a flow diagram of the operation to use a pair of motion sensors embedded in earphones to control the sound volume of the client device that is an audio player in the exemplary case. The motion sensors are accelerometers in our preferred embodiment. The process 600 starts with measuring the output signals of motion sensors by a processor at a predetermined frequency (602). The output signal of a sensor is a digitalized electrical signal representing the motion of an earphone. The sensor embedded with the earphone delivers an output signal when the earphone moves with a change of speed, i.e. from the operation of changing the direction of motion. It is important that a threshold of the signal is defined that filters out all noises related un-intended movement, which is not related to any intended volume adjustment movement. An implementation is described herein for an explanatory purpose but not to limit the scope of the present invention. It should be noted that there are various variations to set the threshold for the motion sensors from the current description. When a user weaves an earphone with an embedded accelerometer, the sensor gives out an output signal with the nature of oscillation around a reference level. The threshold for the detection of a user's interaction, therefore, can be selected as the number of measured cycles of the signal with a sufficient amount of amplitude. The higher the number, the more reliable is for filtering out of the noise. In a practical application a cycle of two to three is sufficient to differentiate a signal from a noise.

The two sensors connected to the processor have a different peripheral identity associated with the ‘up’ or ‘down’ volume status. If the processor receives one of the sensors output signal exceeding the threshold as defined above (604), the processor decides the further action based upon the sensor's identity (606). If the processor detects an exceeding threshold signal from an up-sensor, it checks weather a song is being played (608). The sound volume of earphones is increased according to the strength of the detected sensor signal if the processor confirms that a song is being played and the player is not in the sleep mode (610). Otherwise, the processor turns on the player from the sleep mode and starts to play a song according to the playlist (612). The processor checks the output of the sensor (614) continuously to detect if the ‘up’ signal is persistent after the operation. If the output signal from the sensor is persistent, the sound volume is increased further till the signal from the up-sensor is below the threshold.

On the other hand, if the processor detects an exceeding threshold signal from the down-sensor, it controls an operation to reduce the sound volume of earphones based upon the strength of the detected signal (616). After the reduction of the sound volume, the processor checks if the volume can still be further reduced (618). If a negative response is received, the processor will make a judement that the user intends to switch off the player and the player will be set into the sleep mode (620). Otherwise the processor checks if the signal for reducing sound volume has been below the threshold after the operation (622). If the response is negative, the processor continues to adjust down the volume according to the strength of the signal from the down-sensor till either the received signals from the down-sensor is below the threshold or the player is set into sleep mode.

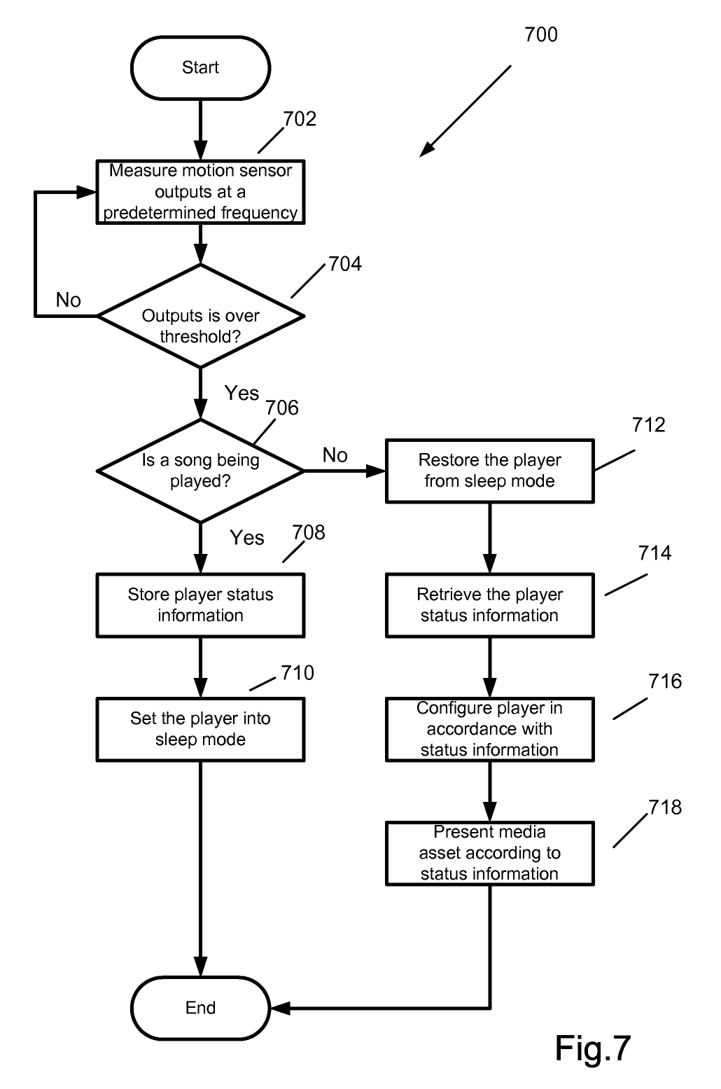

FIG. 7 is a flow diagram of a method to use a motion sensor (accelerometer) embedded in the client device (audio player) to control the ‘pause’ and ‘restore’ operations. The process 700 starts with measuring the output signal of the accelerometer by a processor at a predetermined frequency (702). The output signal of the sensor represents the movement of the player. If the output signal is exceeding the predetermined threshold (704), the processor further checks the status of the player (706). If a song is being played, the processor stores the media player status information (708) and then sets the player into sleep mode (710). Otherwise, the player is in the sleep mode and the processor restarts the processor from the sleep mode (712) and retrieves the recorded player status information (714) and further configures the client device in accordance with the status information (716). The processor further presents media asset according to media player status information (718).

1. A portable media delivery system, comprising a media server and at least one media client device.

2. A media server and a media client device as recited in claim 1, wherein said media server and media client device are connectable via wired connections or wireless connections.

3. A media server as recited in claim 1, wherein said media server is pocket-sized.

4. A media server as recited in claim 1, wherein said media server further comprises:
a display device arranged to display a user interface with user selectable items and;
a user input device to interact with a user and;
a processor that controls the operation of the said media server and;
a file system for providing means to store media assets and;
a cache for providing another means to store media assets and;
a power supply for providing power to the media server.

5. A media client device as recited in claim 1, wherein said media client device further comprises:
a processor that controls the operation of said media client device and;
a cache for providing means to store media assets and;
a power supply for providing power to said media client device.

6. A media server as recited in claim 4, wherein said processor provides means for controlling of operations of said media client device when connected.

7. A media server as recited in claim 1, wherein said media server further comprises a folder containing a user selected playlist of media assets.

8. A media server as recited in claim 7, wherein said playlist is modifiable.

9. A media client device as recited in claim 5, wherein said cache provides means for receiving media assets from the media server.

10. A media client device as recited in claim 5, wherein said media client device further comprises a house with a front surface and a back surface.

11. A media client device as recited in claim 10, wherein said surfaces are with configurations including one with no visible display and no visible user input device.

12. A media device, comprising a detachable sub-system as an enabling part.

13. A detachable sub-system as recited in claim 12, further comprising:
a processor that controls the operation of the media device and the sub-system when detached;
a cache that stores media assets and;
a signal processing unit and;
a power supply for providing power to the sub-system.

14. A detachable sub-system as recited in claim 12, wherein said sub-system is operated as a media player when detached.

15. A sub-system as recited in claim 13, wherein said cache stores media assets selected by a user.

16. A method of controlling operations of a portable device including its accessory devices by using of integrated motion sensors, comprising:
generating signals by the motion sensors from a user's interaction and;
receiving the signals by a control device including a processor and;
comparing the signals with a predetermined threshold and;
generating control signals to output devices.

17. A method as recited in claim 16, wherein said portable device is a media player.

18. A method as recited in claim 16, wherein said motion sensors are accelerometers.

19. A method as recited in claim 16, further comprising a method of controlling operations of the portable device by using of sensors integrated in earphones connected to the portable device.

20. The method as recited in claim 16, further comprising a method of controlling the operations of the portable device by using of motion sensors for detecting a user controlled movements of the portable device or its accessory devices along different directions.
